(19) United States
(12) Patent Application Publication
(10) Pub. No.: US 2024/0167931 A1
(43) Pub. Date: May 23, 2024

(54) Method and System for Calibrating Detection Efficiencies For Condensation Particle Counters

(71) Applicant: Kanomax FMT, Inc., White Bear Lake, MN (US)

(72) Inventor: Derek OBERREIT, Roseville, MN (US)

(73) Assignee: Kanomaz FMT, Inc., White Bear Lake, MN (US)

(21) Appl. No.: 18/550,247

(22) PCT Filed: Mar. 14, 2022
(86) PCT No.: PCT/US2022/020156

§ 371 Date: Sep. 12, 2023

Related U.S. Application Data
(60) Provisional application No. 63/160,447, filed on Mar. 12, 2021.

(51) Int. Cl. G01N 15/10; G01N 15/06

(52) U.S. Cl. CPC G01N 15/1012; G01N 15/065

(57) ABSTRACT

A system, apparatus, and method for accurately calibrating the detection efficiency of condensation particle counters is disclosed. An apparatus for calibrating condensation particle counters includes a container for supplying test particles of a known and constant diameter, a pump communicatively connected to the container, a nanoparticle nebulizer communicatively connected to the pump; an ion mobility classifier communicatively connected to the nebulizer, a first condensation particle counter communicatively connected to the ion mobility classifier; and a second condensation particle counter communicatively connected to the ion mobility classifier.

### BACKGROUND OF THE INVENTION

### 1. Field of the Invention

The present invention relates, generally, to calibration of detection efficiency temperatures for condensation particle counters. The invention facilitates calibration without the need for high resolution particle classification and at low particle concentrations. This method also allows for calibration of nucleation efficiency independent of transport losses.

### 2. Background Information

Calibration of detection efficiencies for condensation particle counters traditionally uses a high resolution particle classifier with an aerosol electrometer to measure the reference concentration. The particle classifier is used to isolate particles based on their electrical mobility, which is a function of the particle diameter and number of charges on the particle: Zₚ(D_{particie}, n_{charges}). The existing method is prone to errors due to the low sensitivity of the reference electrometers, bias in classified particle size distributions due imperfect classifier transfer functions and the shape of the raw (unclassified) particle size distribution. Another significant challenge with the traditional method is correcting/mitigating particles with more than one charge, which are counted as n_{charges}, particles by the aerosol electrometer. These multiply changed particles are physically larger than the nominal classified size for singly charged particles and result in a bias of the detection efficiency towards smaller sizes. While corrections can be made to the measured response, these corrections depend on the raw particle size distribution and an assumption that the charge distribution matches empirically measured values. Existing methods also do not allow for calibration of the activation efficiency independent of transport efficiency, latter of which is size dependent and can skew the result. Mitigation of these concerns facilitates repeatable, high accuracy calibrations of detection efficiencies.

### BRIEF SUMMARY OF THE INVENTION

The invention facilitates calibration without the need for high resolution particle classification and at low particle concentrations. This method also allows for calibration of nucleation efficiency independent of transport losses.

In one aspect, the invention provides an apparatus for calibrating condensation particle counters comprising
a container for supplying test particles;
a pump communicatively connected to the container;
a nebulizer communicatively connected to the pump;
a classifier communicatively connected to the nebulizer;
a first particle counter communicatively connected to the classifier; and
a second particle counter communicatively connected to the classifier.

In another aspect, the invention provides an apparatus for calibrating condensation particle counters comprising
a container for supplying protein test particles of a known and constant diameter between 3.6 and 15 nm in diameter;
a peristaltic pump communicatively connected to the container;
a nanoparticle nebulizer communicatively connected to the pump;
an annular flow ion mobility classifier communicatively connected to the nebulizer;
a first condensation particle counter communicatively connected to the ion mobility classifier; and
a second condensation particle counter communicatively connected to the ion mobility classifier, the second condensation particle counter being a scanning CPC.

The aspects, features, advantages, benefits, and objects of the invention will become clear to those skilled in the art by reference to the following description, claims and drawings.

### BRIEF DESCRIPTION OF THE SEVERAL VIEWS OF THE DRAWING

FIG. 1 is a diagram of an embodiment of the calibrations system of the present invention.

FIG. 2 shows details of the calibration system.

FIG. 3 is a graph showing an effect of dilution.

FIGS. 4 and 5 are graphs showing distributions of materials used to generate results shown.

FIGS. 6 and 7 are graphs shows raw and corrected calibration data.

### DETAILED DESCRIPTION

The description that follows describes, illustrates and exemplifies one or more embodiments of the system and method for measuring chemicals of the present invention. This description is not provided to limit the disclosure to the embodiments described herein, but rather to explain and teach various principles to enable one of ordinary skill in the art to understand these principles and, with that understanding, be able to apply them to practice not only the embodiments described herein, but also other embodiments that may come to mind in accordance with these principles. The scope of the instant disclosure is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers in cases where such labeling facilitates a more clear description. Additionally, the drawings set forth herein are not necessarily drawn to scale, and in some instances proportions may have been exaggerated to more clearly depict certain features.

This invention utilizes a reference condensation particle counter with the capability of detecting 100% of the challenge aerosol. This is confirmed by increasing the temperature difference between the saturator and condenser sections until no change in measured concentration is observed.

The aerosol consists of aerosolized, near-monodipserse (Geometric Standard Deviation<1.05), particles. These particles are dispersed in water with or without buffer or preservative. This mixture is introduced to an ultrafine nebulizer 30 with or without online dilution with high purity water. The concentration of the particles is modified by adjusting offline dilution, online dilution, or a combination of both. The aerosolization method must be designed such that the size of artifact particles formed from precipitated non-volatile residue is negligible (e.g. Kanomax Nano-Particle Nebulizer). For materials that generate residue particles an aerosol classifier 40 (e.g. Kanomax Annular Flow Ion Mobility Classifier) may be used to isolate the desired material.

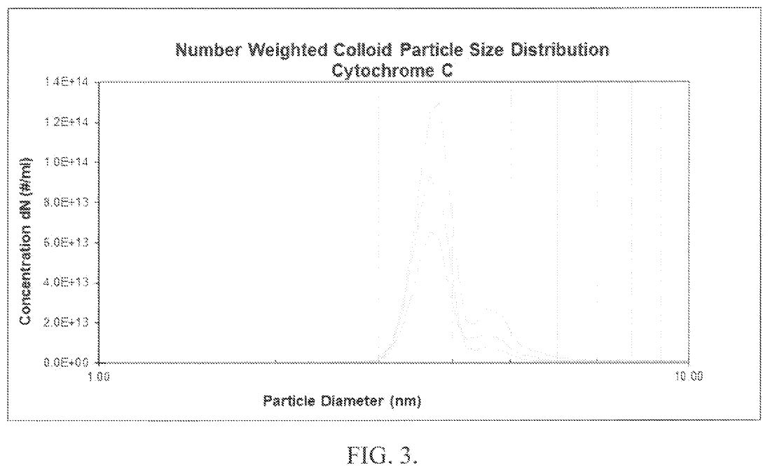

The particles may consist of bio-molecules that are naturally monodisperse (e.g. proteins), size selected material (e.g. polyethylene glycol sized by gel permeation chromatography), synthesized nanoparticles with controlled sizes (e.g. colloidal silica), or any other colloid that has a near mono-disperse size distribution. When aerosolized under fixed conditions the resulting particle size distribution is narrow, stable, and repeatable. FIGS. 3, 4, and 5 show the particle size distributions for three molecules that were used to generate the reference data in this application.

The concentration of the particles prior to aerosolization is controlled to minimize the occurrence of artifact dimers (where two molecules are present within the same nebulized droplet. FIG. 3 shows how sample dilution mitigates this effect.

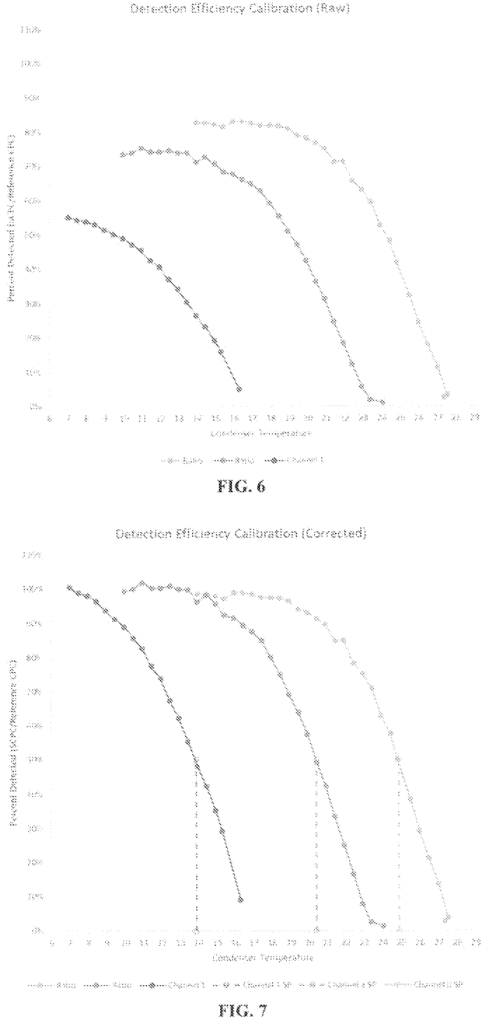

The calibration is performed by adjusting the CPC operating temperatures and measuring the response relative to the reference CPC. The temperatures are adjusted until there is no further change in the ratio of the concentrations between the reference and test CPC. FIGS. 6 and 7 shows the results from this measurement using 3, 9, and 15 nm monodisperse particles. To account for differences in internal transport losses between each instrument (which are a function of the particle size, tubing length, and flowrate) a correction factor is applied to the test CPC concentration to set the asymptote of the ratios to 1. The operating temperatures are then determined by finding the temperature where the concentration ratio is 50% as shown in FIG. 7.

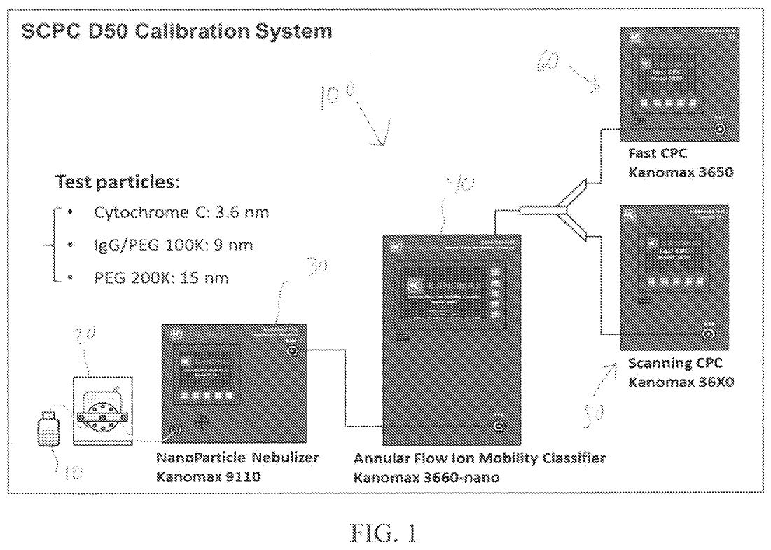

FIG. 1 is a diagram of an embodiment of the calibration system 10 of the present invention. The system 100 comprises a sample input container 10 connected to a pump 20 which is connected to a nano-particle nebulizer 30 which is connected to an annular flow ion mobility classifier 40 which is connected to a fast condensation particle counter (CPC) 60 and to a scanning condensation particle counter 50. The nebulizer 30 is preferably a Kanomax 9100. The classifier 40 is preferably a Kanomax 3660-Nano. The Fast CPC is preferably a Kanomax 3650. And the scanning CPC is preferably a Kanomax 36XO. Test particles include Cytochrome C (3.6 nm). IgG/PEG 100K (9 mn), and PEG 200K (15 nm).

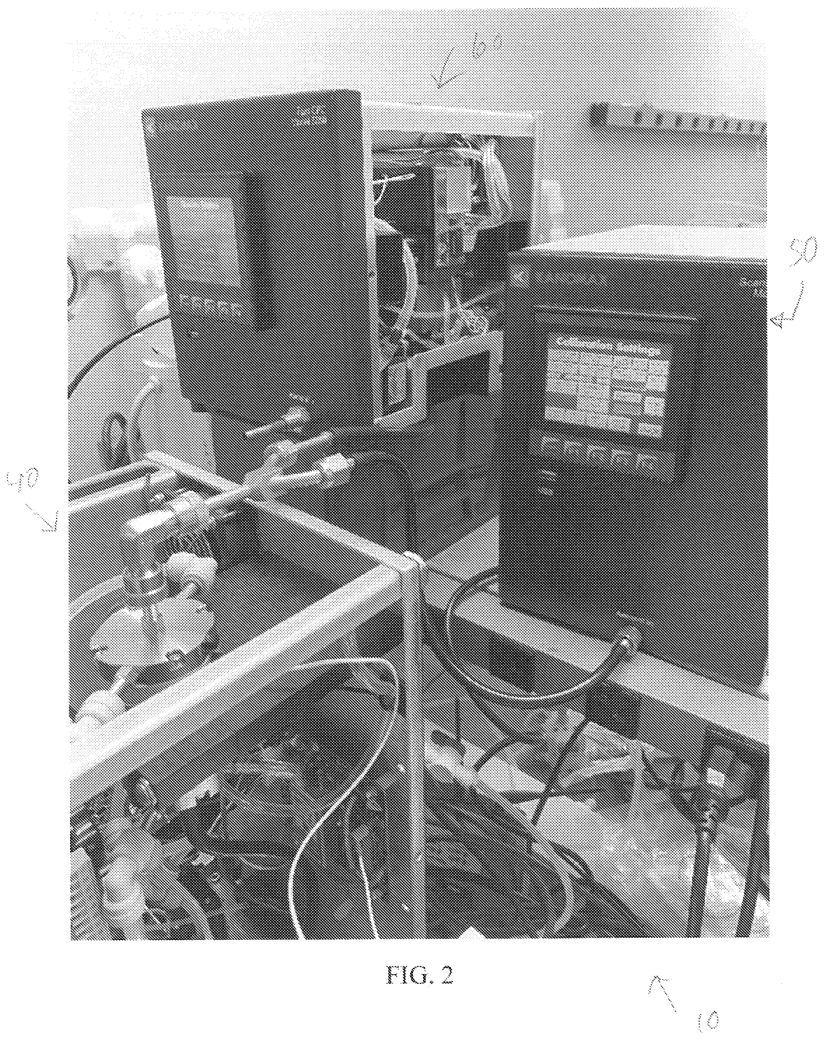

FIG. 2 shows details of the calibration system.

FIG. 3 is a graph of showing an effect of dilution in minimizing artifact dimers. It illustrates the number weighted colloid size particle size distribution for Cytochrome C. The graph shows particle diameter, in nanometers (nm) versus concentration (dN) No. per milli liter.

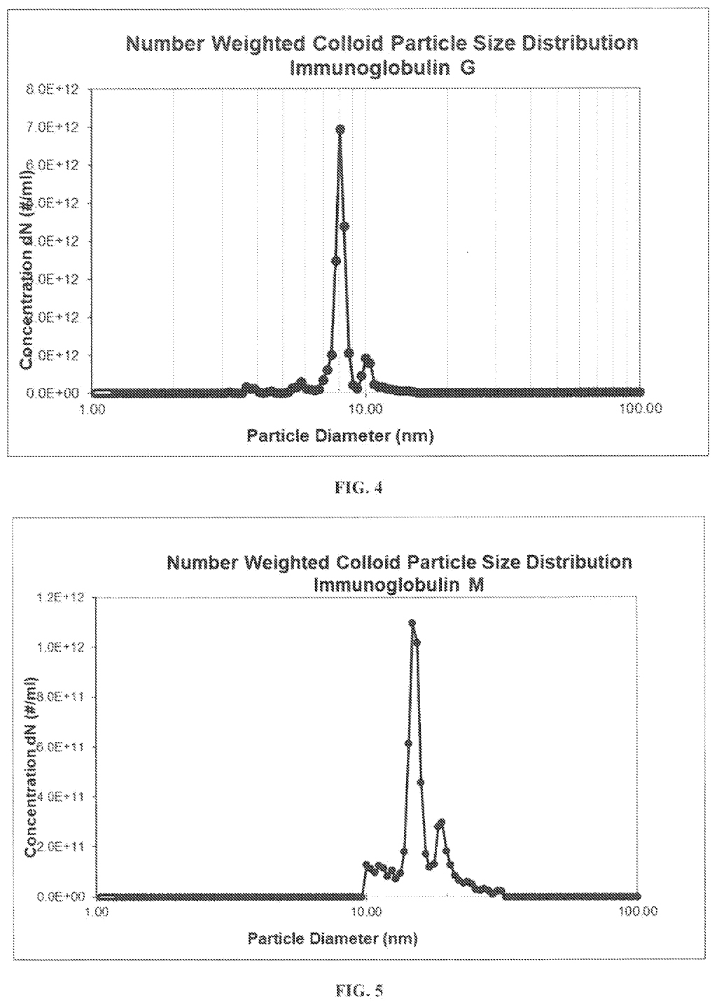

FIGS. 4 and 5 are graphs show distributions of materials used to generate the data shown. They illustrate number weighted colloid particle size distribution for Immunoglobulin G (FIG. 4) and M (FIG. 5). The graph shows particle diameter in nm versus concentration dN (No. per ml.). Graph A

FIGS. 6 and 7 are graphs shows sample calibrations both raw (FIG. 6) and corrected (FIG. 7) calibration data. The graphs illustrate detection efficiency with temperature on the X axis versus percent detected on the Y axis.

Although the systems, apparatus, and methods of the invention have been described in connection with the field of chemical measurement and analysis, it can readily be appreciated that the invention is not limited solely to such fields, and can be used in other fields.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably.” “removable.” and the like near the word “coupled,” and the like does not mean that the coupling, etc. in question is or is not removable.

As defined herein. “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments. “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be umforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. An apparatus for calibrating condensation particle counters comprising
a container for supplying test particles;
a pump communicatively connected to the container;
a nebulizer communicatively connected to the pump;
a classifier communicatively connected to the nebulizer;
a first particle counter communicatively connected to the classifier; and
a second particle counter communicatively connected to the classifier.

2. The apparatus of claim 1, wherein the test particles have a known and constant diameter.

3. The apparatus of claim 2, wherein the test particle is a protein

4. The apparatus of claim 3, wherein the protein is selected from a group consisting of Cytochrome, IgG/PEG, and PEG 200K.

5. The apparatus of claim 2, wherein the test particle size ranges from 3.6 nm to 15 nm.

6. The apparatus of claim 1, wherein the pump is a peristaltic pump.

7. The apparatus of claim 1, wherein the nebulizer is a nanoparticle nebulizer.

8. The apparatus of claim 7, wherein the nanoparticle nebulizer is a Kanomax 9100 nebulizer.

9. The apparatus of claim 1, wherein the classifier is an ion mobility classifier.

10. The apparatus of claim 9, wherein the ion mobility classifier is an annular flow ion mobility classifier.

11. The apparatus of claim 10, wherein the ion mobility classifier is a Kanomax 3660 classifier.

12. The apparatus of claim 1, wherein the first particle counter is a first condensation particle counter.

13. The apparatus of claim 12, wherein the first condensation particle counter is a Fast Condensation Particle Counter.

14. The apparatus of claim 13, wherein the Fast Condensation Particle Counter is a Kanomax 3650 Fast CPC.

15. The apparatus of claim 1, wherein the second particle counter is a second condensation particle counter.

16. The apparatus of claim 15, wherein the second condensation particle counter is a scanning condensation particle counter.

17. The apparatus of claim 16, wherein the scanning condensation particle counter is a Kanomax 36X0 Scanning CPC.

18. An apparatus for calibrating condensation particle counters comprising
a container for supplying test particles of a known and constant diameter;
a pump communicatively connected to the container;
a nanoparticle nebulizer communicatively connected to the pump;
an ion mobility classifier communicatively connected to the nebulizer;
a first condensation particle counter communicatively connected to the ion mobility classifier; and
a second condensation particle counter communicatively connected to the ion mobility classifier.

19. A system for calibrating condensation particle counters comprising
a. a container for supplying protein test particles of a known and constant diameter between 3.6 and 15 nm in diameter;
b. a peristaltic pump communicatively connected to the container;
c. a nanoparticle nebulizer communicatively connected to the pump;
d. an annular flow ion mobility classifier communicatively connected to the nebulizer;
e. a first condensation particle counter communicatively connected to the ion mobility classifier; and
f. a second condensation particle counter communicatively connected to the ion mobility classifier, the second condensation particle counter being a scanning CPC.
